(19) United States
(12) Patent Application Publication
(10) Pub. No.: US 2005/0000747 A1
(43) Pub. Date: Jan. 6, 2005

(54) Radio for a motorcycle

(75) Inventors: Jeffrey E. Richlen, Oak Creek, WI (US); Daniel A. Matre, Wauwatosa, WI (US); James M. Busse, Kenosha, WI (US); Nelson J. Cobb, Palmyra, WI (US)

Correspondence Address: MICHAEL BEST & FRIEDRICH, LLP, 100 E WISCONSIN AVENUE, MILWAUKEE, WI, 53202, US

(73) Assignee: Harley-Davidson Motor Company Group, Inc., Milwaukee, WI (US)

(21) Appl. No.: 10/611,620

(22) Filed: Jul. 1, 2003

(51) Int. Cl. B62M 7/00

(52) U.S. Cl. 180/219

(57) ABSTRACT

A motorcycle including a frame defining left and right sides and a riser supported by the frame. An electronic device including a housing is coupled to the riser. The housing has a left portion disposed on the left side and a right portion disposed on the right side. The motorcycle also includes a plurality of controls on the housing operable to control the electronic device, wherein a majority of the plurality of controls are located on the left portion.

### BACKGROUND OF THE INVENTION

The present invention generally relates to mobile electronic devices, and particularly to audio devices for use on motorcycles.

Radios or other audio devices can enhance the riding experience on a motorcycle. However, motorcycles have limited space for accessories such as radios. In addition, the accessories must be supported such that the operator has adequate access without compromising his or her ability to control the motorcycle.

### SUMMARY OF THE INVENTION

The present invention includes an electronic device that is particularly adapted for use on a motorcycle having a handlebar riser. The electronic device includes a housing that is coupled to the riser. The electronic device also includes a plurality of controls on the housing operable to control the electronic device, and a majority of the controls are located on the left side of the housing. In one embodiment, the electronic device includes a display in the middle. Positioning a majority of the controls on the left side facilitates operation of the controls by the user's left hand without visual obstruction of the display and without the need to remove the user's right hand from the throttle.

In another aspect of the present invention, the electronic device includes a flange extending from the housing above the controls. The flange supports the user's fingers (e.g., on the user's left hand) while allowing access to the controls by the user's thumb.

In yet another aspect of the invention, the electronic device includes a break-away mounting system. The break-away mounting system includes a first bracket connected to the motorcycle, and a second bracket connected to the electronic device and detachably connected to the first bracket. Rotation of the second bracket relative to the first bracket disengages the second bracket from the first bracket.

In another aspect of the invention, the electronic device is mounted to the motorcycle riser using a unique method. The method includes removing a first riser screw from the riser, positioning a bracket adjacent the riser, and inserting a second riser screw through the bracket to attach the bracket to the riser. The method also includes attaching the electronic device to the bracket.

### BRIEF DESCRIPTION OF THE DRAWINGS

The detailed description particularly refers to the accompanying figures in which:

FIG. 1 is a perspective view of a portion of a motorcycle including an electronic device embodying the present invention;

FIG. 2 is a front view of the electronic device of FIG. 1;

FIG. 3 is a perspective view of a portion of a mounting bracket supporting the electronic device of FIG. 1;

FIG. 4 is a side view of the electronic device of FIG. 1 in a first position;

FIG. 5 is a perspective view of the mounting bracket of FIG. 3;

FIG. 6 is a top view of the mounting bracket of FIG. 5;

FIG. 7 is a section view of the mounting bracket taken along line 7-7 of FIG. 6;

FIG. 8 is a section view similar to FIG. 7, illustrating the upper bracket of the mounting bracket rotated relative to the lower bracket of the mounting bracket;

FIG. 9 is a perspective view of the motorcycle with the upper bracket and the electronic device disengaged; and

FIG. 10 is a block diagram illustrating the functions of a radio embodying the present invention.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The use of “consisting of” and variations thereof herein is meant to encompass only the items listed thereafter. The use of letters to identify elements of a method or process is simply for identification and is not meant to indicate that the elements should be performed in a particular order.

### DETAILED DESCRIPTION OF THE DRAWINGS

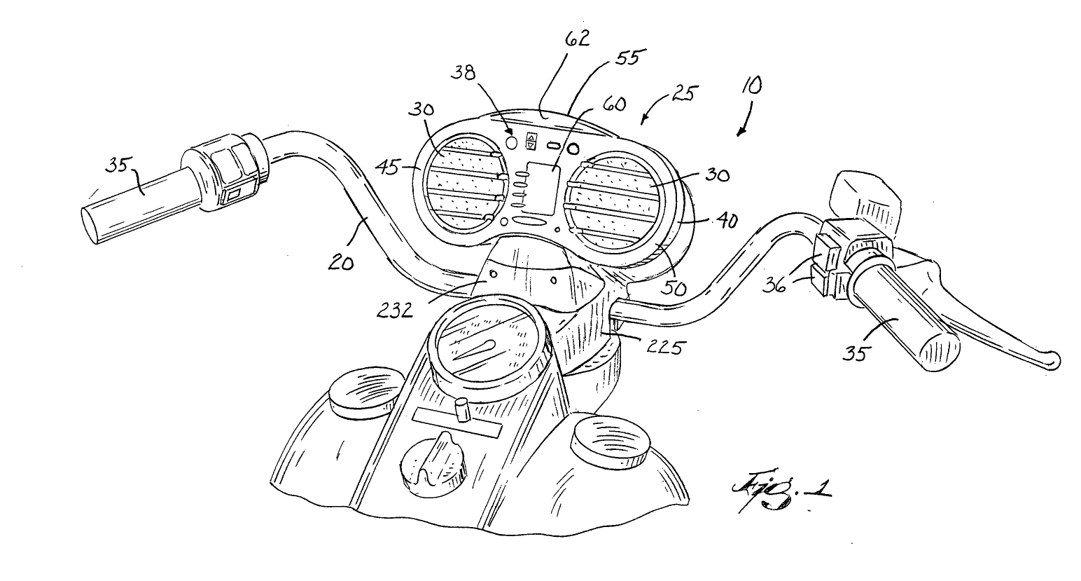

FIG. 1 illustrates a motorcycle 10 including an electronic device embodying the present invention. The motorcycle 10 includes handlebars 20, and the electronic device, such as a radio 25, is mounted to the motorcycle 10. Before describing the preferred embodiment in detail, it should be noted that the term “electronic device” as used herein is meant to include many different devices (e.g., compact disk player, MP3 player, cassette tape player, digital videodisk player, radio, etc.). Thus, while the preferred embodiment will be described as including a radio 25 and speakers 30, a person having ordinary skill in the art will realize that many other electronic devices could be used with the present invention in place of the radio 25 and speakers 30.

The handlebars 20 include two handgrips 35 that support various controls needed for motorcycle operation. For example, the right handgrip includes the throttle control and may include buttons 36 for turn signals or a horn. In addition, the handlebars 20 rotate about the steering head axis to turn the front wheel and steer the motorcycle 10. A mounting bracket 37 (described below) attaches the radio 25 and speakers 30 to the handlebars 20 between the handgrips 35.

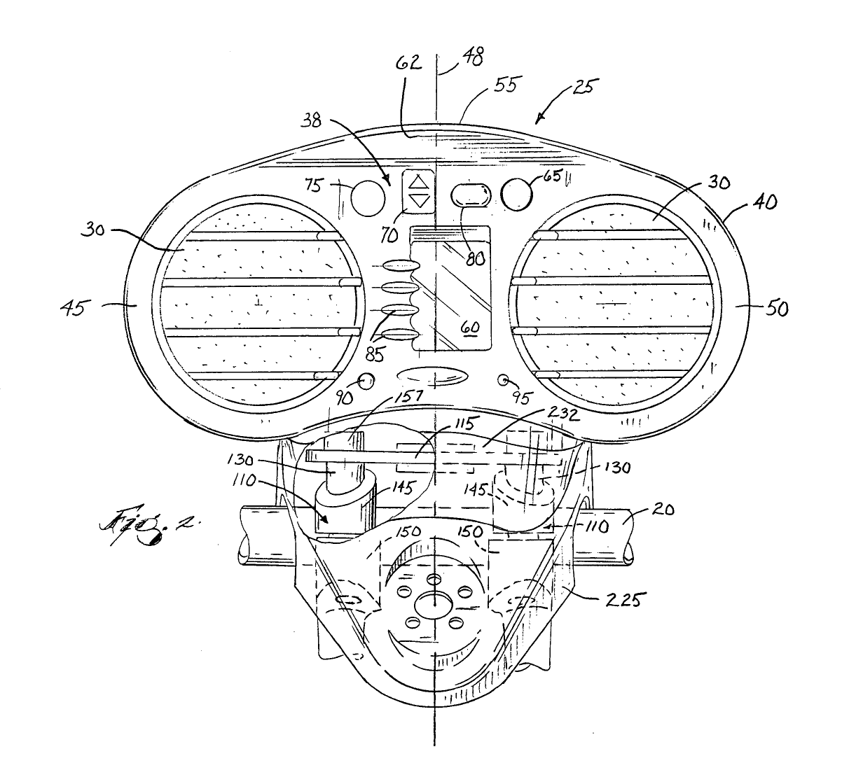

Turning to FIG. 2, a front view of the radio 25 illustrates the location of the speakers 30 and the radio controls 38. The radio 25 and speakers 30 are substantially contained within a housing 40 having a left portion 45, a right portion 50, and a top portion 55. The motorcycle 10 includes a longitudinal axis 48 laterally centered on the motorcycle 10. The longitudinal axis 48 defines left and right sides of the motorcycle. One speaker 30 is disposed in each of the left and right sides 45, 50 to allow the radio 25 to produce a stereo effect. A display 60 is positioned near the center of the housing 40, while a majority of the controls 38 are positioned on the left portion 45 of the housing 40.

During operation of the motorcycle 10, it is desired for the operator to maintain control of the throttle position to control the speed of the motorcycle 10. Thus, the operator is generally unable to remove his or her right hand from the handgrip 35 without reducing speed. Therefore, it is desired that all of the radio controls 38 be easily actuated with the user's left hand. By positioning a majority of the controls 38 on the left portion 45 of the housing 40, an operator is able to actuate the controls 38 without blocking the view of the central display 60. In addition, the few controls 38 that are positioned in the right portion 50 of the housing 40 are positioned in a row adjacent the top portion 55 of the radio 25 to allow the operator to actuate them with his or her left hand without blocking the display 60.

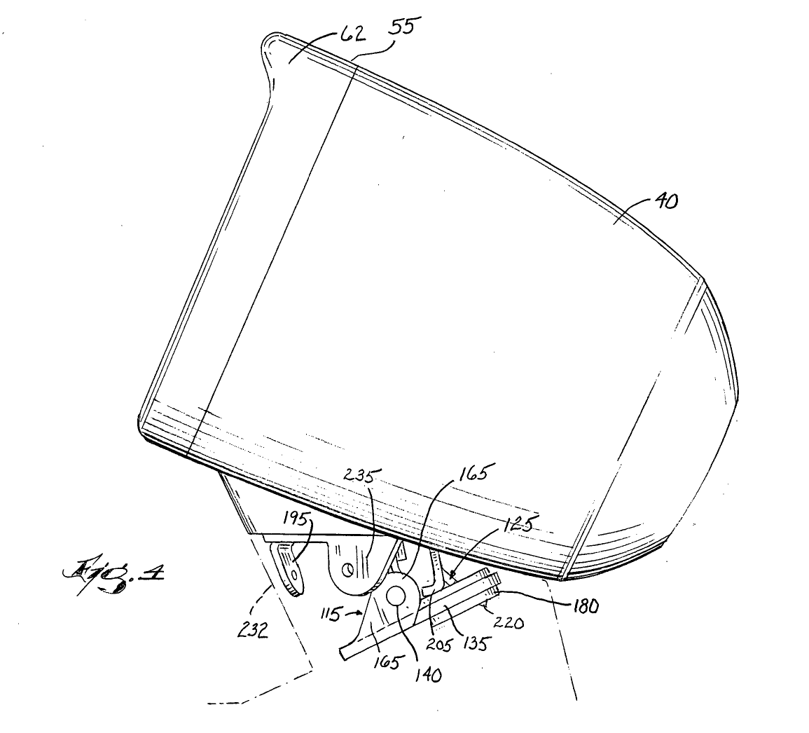

As best shown in FIG. 4, the top 55 of the housing 40 includes a flange 62 that provides a comfortable support for the operator's fingers while the operator manipulates the controls 38. This allows the operator to maintain a steady hand while actuating the controls 38 thereby providing improved fine motor skills of the operator's thumb. The positions of the controls 38 allow the operator to position his or her left fingers on the flange 62 while actuating the controls 38 with the left thumb.

While many different controls 38 may be employed, the radio 25 illustrated in FIG. 2 includes a mute button 65, an up/down control 70, a power control 75, a mode control 80, and four display buttons 85. The most commonly used controls, namely the power control 75 and up/down controls 70 are positioned in the upper part of the left portion 45 of the housing 40. The next most commonly used buttons, namely the display buttons 85, are positioned immediately below the power control 75 and up/down buttons 70 within the left portion 45 of the housing 40. Finally, the least used buttons, the mode control 80 and the mute button 65 are positioned in the upper part of the right portion 50 of the housing 40.

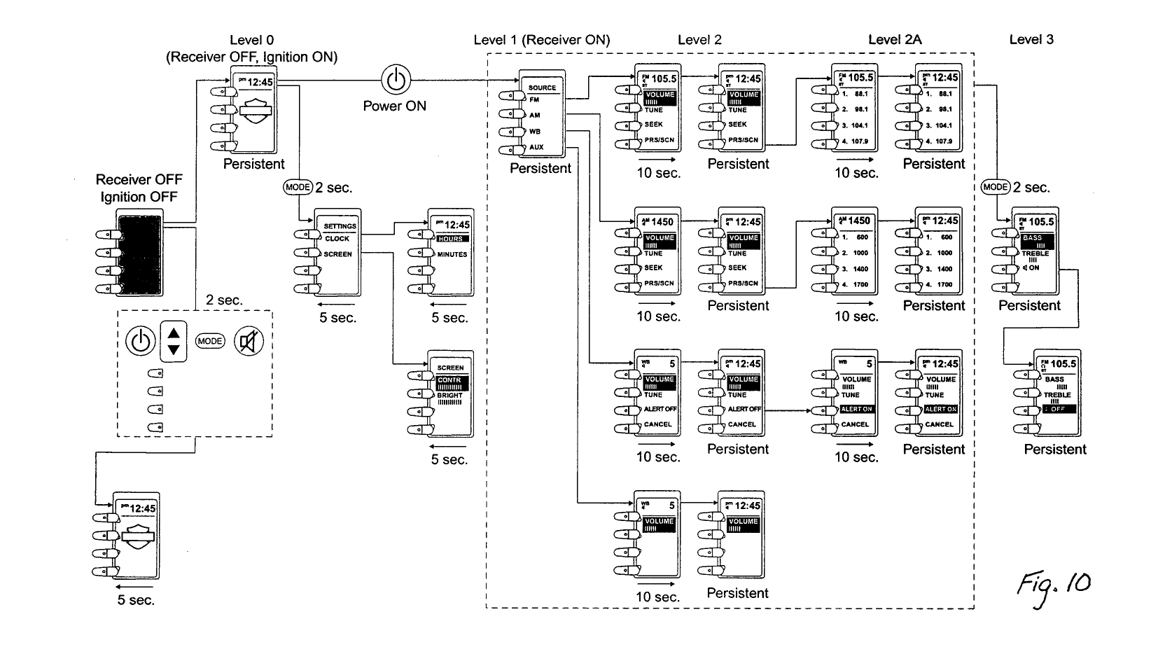

FIG. 10 illustrates in block format the operation of the radio 25 and the functions of the different controls 38. When the radio is turned on and the motorcycle ignition is on, the display 60 will present the Level 1 information. The Level 1 display shows a source selection list including four sources (FM, AM, WB, or AUX) for selection. Once a source is selected by pressing the adjacent display button 85, the display 60 will present the Level 2 information corresponding to the source selection. The Level 2 displays are different depending on the source. The FM and AM Level 2 displays include a volume selection, a tune selection, a seek selection, and a preset/scan selection (PRS/SCN). Selecting volume, tune, or seek activates the toggle switch 70 to allow the user to control the desired adjustment. A single, quick press of the preset/scan selection transitions the display 60 to Level 2A, where a list of preprogrammed frequency presets are displayed. The user is able to select a desired frequency by selecting the display button 85 adjacent the displayed frequency. If the radio is turned off, the selections made at Levels 1, 2, and 2A remain when the radio is again switched on.

If the preset/scan button is pressed and held in Level 2, it will initiate a timer controlled scanning of the pre-programmed preset stations. Preferably, the system will determine if the signal strength of the preset station is adequate to stop rather than simply stepping through all of the presets without regard to range. This prevents stopping on a pure static station that is out of range. If the preset is out of range, it simply skips the selection and moves to the next preset station. The scanning feature can be disabled by pressing any other button on the radio 25 other than the mute button.

Pressing the mode button 80 allows the user to return to Level 2 from Level 2A, and return to Level 1 from Level 2 to adjust the various settings. In addition, pressing and holding the mode button 80 in Levels 1, 2, and 2A will allow the user to access the Level 3 functions, which include the bass, treble, and speaker ON/OFF controls. With the motorcycle ignition on and the radio power off, various settings such as screen contrast and clock settings can be adjusted by pressing and holding the mode button 80 to display these Level 0 functions. With the ignition in the off position, and the radio off, the display is blank. From this setting, the screen 60 is activated to illustrate the time when any of the display buttons 38 are pressed and held.

It should be noted that only a few controls 38 have been described herein. Many other radio controls 38 are known and contemplated by the present invention. In addition, many other radios or electronic devices may be supported and attached to a motorcycle using the invention described herein. Therefore, the invention should not be limited to the specific radio just described.

Turning again to FIG. 2, the illustrated radio 25 also includes an auxiliary input jack 90 and an auxiliary output jack 95. The auxiliary input jack 90 allows for the connection of an input device to the radio 25. For example, a portable CD player could be connected to the auxiliary input jack 90 to allow the CD player output to be broadcast from the radio speakers 30. Likewise, the auxiliary output jack 95 allows for the connection of auxiliary output devices such as headphones. The speakers 30 can be turned off by accessing the speaker controls in the Level 3 functions of the display 60.

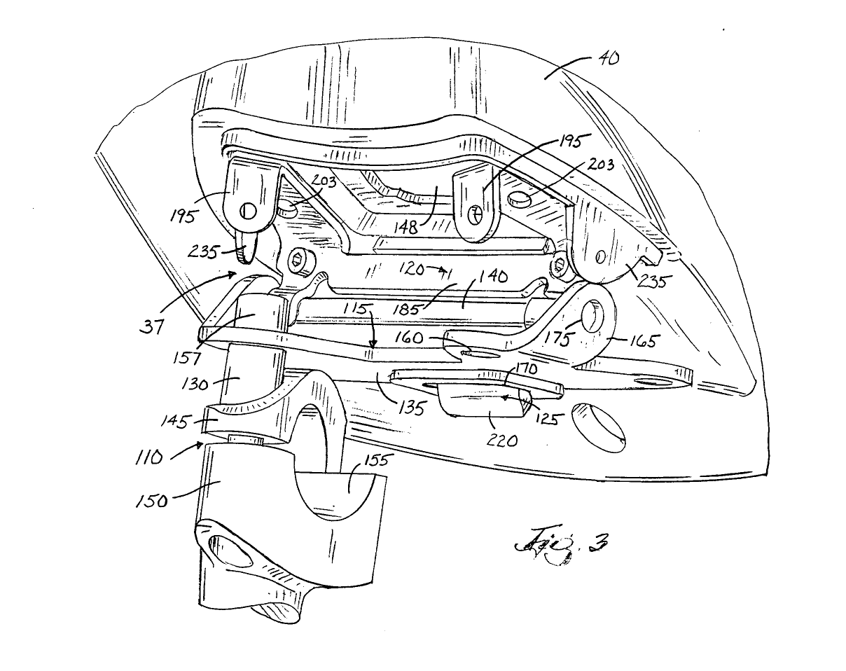

FIG. 3 is a bottom perspective view of the radio 25 and better illustrates the mounting bracket 37 supporting the radio 25. The mounting bracket 37 attaches to risers 110 (only one shown in FIG. 3) through spacers 130. The mounting bracket 37 includes a first bracket such as a lower bracket 115, a second bracket such as an upper bracket 120, and a pivot stop 125. The lower bracket 115 includes a lower platform 135 and a pivot bar 140. Although not illustrated, the radio 25 includes wires that connect the radio 25 to an electrical system of the motorcycle 10 and to an external antennae. These wires can be connected by a typical plug and socket connection located generally within the cavity 148.

Each of the risers 110 includes an upper portion 145 and a lower portion 150 that cooperate to define a bore 155. The bore 155 is sized to receive and clamp the handlebar 20 at the desired attachment location. Typical motorcycles use a short screw to clamp the riser 110 closed. To attach the radio 25, longer screws 157 and spacers 130 are used with the riser 110.

The spacer 130 provides an extension that allows the lower platform 135 to sit above the riser 110. The spacer 130 is essentially a tubular member that extends above the riser 110. The screw 157 passes through the lower platform 135, the spacer 130, and the upper portion 145 of the riser 110 before engaging the lower portion 150 of the riser 110. Thus, tightening of the screw 157 not only attaches the riser 110 to the handlebar 20, but also attaches the lower platform 135 to the spacer 130.

While a circular or tubular spacer 130 is illustrated, any shape will facilitate the proper positioning of the lower platform 135. In addition, other constructions of the invention could employ a riser 110 having an upper portion and a spacer integrally formed as one piece. Likewise, the spacer 130 could be integrally formed with the lower platform 135. It should be noted that FIG. 3 illustrates one riser 110 and spacer 130 with the second riser and spacer being omitted for clarity. FIG. 2 shows both risers 110 in their attachment position. Other constructions of the invention could employ a single riser 110 and spacer 130 to attach the radio 25 or other device to the handlebar 20.

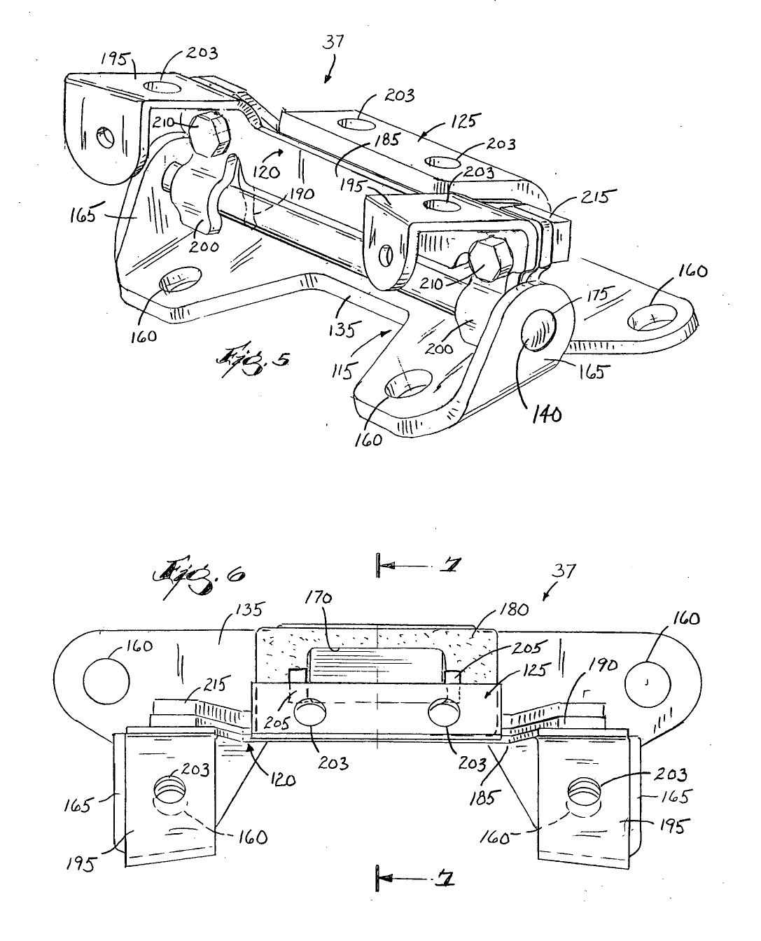

The lower platform 135, illustrated best in FIGS. 5 and 6, includes four attachment bores 160, two ears 165, and a slot 170. The four attachment bores 160 are large enough to receive the riser screws 157. The ears 165 extend away from the plane of the lower platform 135 at an angle of approximately 90° to provide support points for the pivot bar 140. Each ear 165 includes a bore 175 (FIG. 5) sized to receive the pivot bar 140.

The pivot bar 140 is generally a round bar or tubular member that extends between the ears 165 and provides a support around which the upper bracket 120 can pivot. Many methods of fixing the pivot bar 140 in position are known and contemplated by the invention. For example, a keyway could be provided that fixedly engages the bar 140 and the ears 165 to prevent rotation. In another construction, a small screw attaches the bar 140 to the ears 165 and prevents rotation. In still other constructions, the bar 140 is welded, brazed, soldered, glued, or otherwise fixedly attached to the ears 165. Alternatively, the bar 140 could be rotatably coupled to the ears 165.

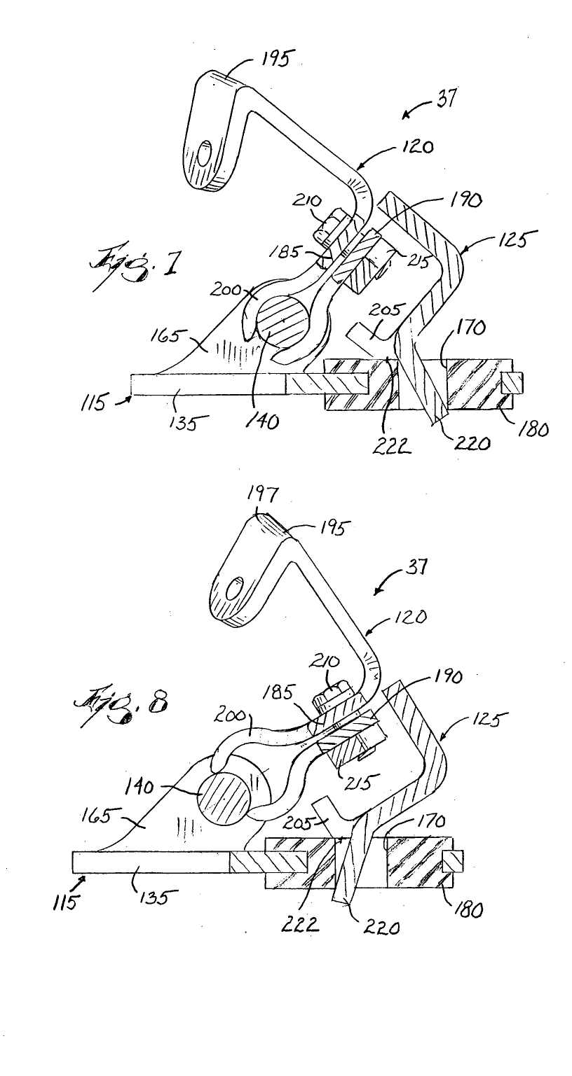

The slot 170, best illustrated in FIGS. 6 and 7, comprises a rectangular or oval shaped opening that is positioned to engage a portion of the pivot stop 125 at certain positions. The function of the slot 170 will be described in greater detail below. A grommet 180 is positioned within the slot 170 to provide a soft surface that maintains the necessary friction between the slot 170 and portions of the pivot stop 125 when they engage each other. Generally, the grommet 180 is rubber with other flexible or elastomeric materials being possible. In still other constructions, the grommet 180 is not used. While a rectangular or oval slot 170 has been described, many other shapes will also function as the slot 170. For example, square or rectangular openings will function as slots. In addition, more than one opening can be used to perform the function of the slot 170.

As is best illustrated in FIGS. 5-8, the upper bracket 120 includes first and second clamp portions 185, 190 that define a removable C-shaped clamp. The first clamp portion 185 is an essentially L-shaped piece that includes mounting tabs 195 on one leg and pivot tabs 200 on the other leg. The mounting tabs 195 contact the housing 40 of the radio 25 or other device and provide a convenient attachment location. Screws or other fasteners extend through attachment bores 203 in the mounting tabs 195 and engage the housing 40 to firmly affix it to the first clamping portion 185. The pivot tab 200 includes an arcuate curved portion that is shaped to engage the pivot bar 140.

The second clamp portion 190 is essentially a mirror image of the pivot tab 200 of the first clamp portion 185. Thus, the second clamp portion 190 when juxtaposed with the first clamp portion 190 defines the complete C-shaped clamp that is attachable to the pivot bar 140. One or more screws 210 pass through both the first and second clamp portions 185, 190 before engaging a threaded backing member 215. Once tightened, the screws 210 and the backing member 215 apply a clamping force along the entire length of the first and second clamp portions 185, 190. Thus, the upper bracket 120 pivotally attaches the radio 25 or other device to the pivot bar 140 and to the motorcycle 10.

The pivot stop 125 defines a tail portion 220 that extends within the slot 170 of the lower platform 135. The pivot stop 125 includes legs 205 on opposite sides of the tail portion 220. The pivot stop 125 also includes two attachment bores 203 that facilitate attachment of the pivot stop 125 to the housing 40. Because the pivot stop 125 is mounted to the housing 40, the pivot stop 125 rotates with the upper bracket 120, which is also connected to the housing 40. The pivot stop 125 could alternatively be connected to the upper bracket 120 or both the upper bracket 120 and the housing 40.

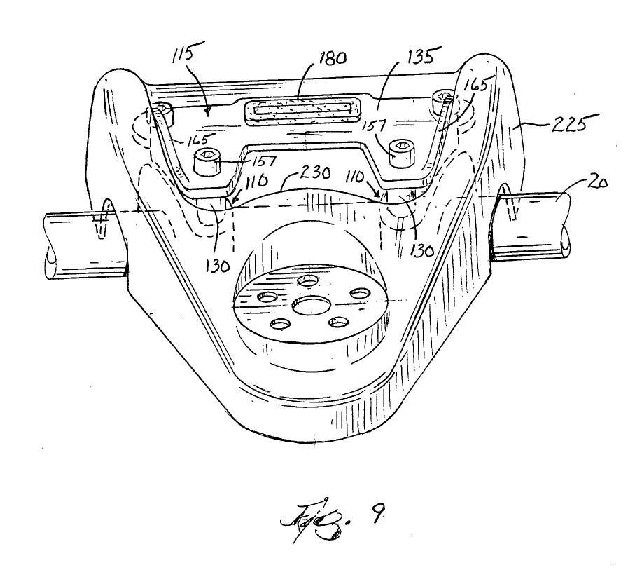

FIGS. 7-8 illustrate pivoting and disconnecting the radio 25 from the motorcycle 10. In FIG. 7, the radio 25 is positioned in the first or normal operating position at an angle that would allow an operator to view the display 60 (also illustrated in FIG. 4). As shown in FIGS. 7, the tail portion 220 of the pivot stop 125 inhibits the radio 25 and upper bracket 120 from pivoting relative to the lower bracket 115. In this position, the tail portion 220 of the pivot stop 125 is in contact with the surface of the grommet 180 within the slot 170, thereby preventing any rotation of the radio 25 about the pivot bar 140.

In alternate embodiments, the tail portion 220 of the pivot stop 125 can be designed to provide the radio 25 and the upper bracket 120 some degree of adjustability prior to disconnecting from the pivot bar 140. The adjustable bracket 120 can provide alternate positions of the radio 25 to accommodate different models of motorcycles and adjust the viewing angle to fit taller and shorter operators. In this configuration, the illustrated flexible skirt 232 can flex to allow variations in radio position, however, a bellowed or hinged skirt 232 is preferred.

As illustrated in FIG. 8, a substantial forward force (approximately aligned with the longitudinal axis of the motorcycle 10) applied to the radio 25 or mounting bracket 37 will cause rotation of the upper bracket 120 relative to the lower bracket 115 about the axis 222 defined by the line of contact between the grommet 180 and the legs 205 of the pivot stop 125. The rotation forces the first and second portions 185, 190 to bend apart from each other, thereby releasing the radio 25 from the pivot bar 140. In this manner, an impact or large force acting on the radio 25 will force the C-shaped clamp to fully disengaged from the pivot bar 140, thereby allowing the radio 25 to freely move in the direction of the force being applied. As the radio 25 pivots, the legs 205 roll along the upper surface of the grommet 180. In some embodiments, the tail portion 220 contacts the inner surface of the grommet 180 causing the legs 205 to slide some distance along the upper surface of the grommet 180. This combination of movements allows the upper bracket 120 to cleanly release from the lower bracket 115 without binding under the shaft 140.

It should be noted that the wires that connect the radio 25 to motorcycle 10 are provided with enough extra length (i.e., slack) to allow the radio to safely move from the area between the handlebars 20. In other embodiments, the wires could be connected to the radio with plugs that are designed to quickly disconnect when the radio disengages from the lower bracket 115.

To attach the radio or other audio device to a motorcycle, the operator first removes the existing riser cover and the short riser screws. As illustrated in FIG. 9, the spacers 130 are then positioned on the risers 110, and the lower bracket 115 is then positioned on the spacers 130. Long riser screws 157 are then inserted through the lower platform 135, the spacers 130, and the upper portions 145 of the risers 110 before engaging the lower portions 150 of the risers 110. Tightening the screws fixedly connects the lower bracket 115 to the risers 110. It should be noted that the term “connect” as used herein with regard to the lower bracket 115 and riser 110 can mean a direct connection or a connection through an additional clamp or through an additional clamp and spacer. A new cover 225 is positioned over the risers 110 to substantially cover the risers 110. The new cover 225 includes an opening 230 sized to allow access to the lower bracket 115 and risers 110. In another construction, the existing riser cover is modified to include the opening 230 rather than replacing it with a new cover 225. The radio or other audio device 25 attaches to the lower bracket 115 through the upper bracket 120. A trim skirt 232 (FIG. 1, 2, and 4) is connected to the mounting tabs 195 of the upper bracket 120 and to the flanges 235 that extend downwardly from the bottom of the housing 40. The trim skirt 232 extends between the housing 40 and the cover 225 to hide the mounting bracket 37 from view. The trim skirt 232 is made from a semi-rigid plastic such as polypropylene or polyethylene, and could alternatively be made of materials such as leather, rubber, urethane, or other more flexible materials. In another construction, the lower bracket 115 attaches to the electronic device 25 before attaching to the motorcycle 10.

Although the invention has been described in detail with reference to certain preferred embodiments, variations and modifications exist within the scope and spirit of the invention as described and defined in the following claims.

1-16. (Cancelled)

17. A break-away mounting system for mounting an electronic device to a motorcycle, the break-away mounting system comprising:
a first bracket connectable to the motorcycle;
a second bracket connectable to the electronic device and detachably connected to the first bracket, wherein rotation of the second bracket relative to the first bracket disengages the second bracket from the first bracket.

18. The break-away mounting system of claim 17, wherein the motorcycle includes a spacer and a riser having lower and upper portions, and wherein the spacer extends above the upper portion and is connected to the first bracket.

19. The break-away mounting system of claim 17, wherein the first bracket further comprises a bar, and wherein the second bracket includes an attachment portion that is substantially C-shaped, and wherein the attachment portion is detachably connected to the bar.

20. The break-away mounting system of claim 17, wherein the electronic device is an audio device.

21. The break-away mounting system of claim 17, wherein the second bracket includes legs that contact the first bracket along a line of contact, and wherein rotation of the second bracket relative to the first bracket about the line of contact disengages the second bracket from the first.

22. The break-away mounting system of claim 17, wherein the first bracket includes an aperture, and wherein the second bracket includes a tail portion extending through the aperture.

23. The break-away mounting system of claim 22, further comprising a grommet disposed within the aperture.

24. A method of detaching an electronic device from a motorcycle, the method comprising:
connecting a first bracket to the motorcycle;
detachably connecting a second bracket to the first bracket;
connecting an electronic device to the second bracket;
rotating the electronic device and the second bracket relative to the first bracket; and
disengaging the electronic device from the motorcycle as the electronic device and the second bracket rotate relative to the first bracket.

25. The method of claim 24, wherein rotating the electronic device and the second bracket includes rotating the electronic device and the second bracket relative to the first bracket about a line of contact between the first bracket and legs of the second bracket.

26. The method of claim 24, wherein disengaging the electronic device from the motorcycle includes spreading apart leg portions of the second bracket to allow the second bracket to disengage from the first bracket.

27-31. (Cancelled)

32. The method of claim 24, wherein the connecting step further comprises connecting the first bracket to a riser.
